(19) United States
(12) Patent Application Publication
(10) Pub. No.: US 2010/0031515 A1
(43) Pub. Date: Feb. 11, 2010

(54) Grounds tool with means for transposable grips

(76) Inventor: Edward Patrick Hurley, Sara Sota, FL (US)

Correspondence Address: Maxey Law Offices, PLLC, 13630 58TH ST. NORTH, SUITE 101, CLEARWATER, FL, 33760, US

(21) Appl. No.: 12/287,548

(22) Filed: Oct. 10, 2008

Related U.S. Application Data
(63) Continuation-in-part of application No. 12/228,208, filed on Aug. 11, 2008, now abandoned.

(51) Int. Cl. A01D 34/412

(52) U.S. Cl. 30/276

(57) ABSTRACT

A grounds tool with means for transposable grips with an upright input arm having a first grip and a trigger, an output arm having a line filament or bladed working end and a button or a dual button end couples the input arm, the button engages a mid-slot or the dual button engages mirrored slots forming a boom, a motor on the boom for driving the line filament and bladed tools, the output arm held within left and right mirrored isometry folds having a second grip to transpose a third and forth grip, the second control grip and the tools having to transpose congruently with the button folds, a front suspension complementary and supplementary to the operator shield radian walls that are about twice the boom tilt, a chamber having to duplicate, reciprocate or reverse the tools with uniform airflow and the fifth grip having to translate the motor.

### CROSS REFERENCE TO RELATED APPLICATIONS

This is a continuation in part of Ser. No. 12/228,208, filed on Aug. 11, 2008.

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of grounds maintenance and more specifically to a grounds tool with means for transposable grips.

The annual ten-billion dollar plus US Outdoor Power Equipment Industry is separated into two design categories in which line filament and bladed grounds tools are mounted onto machines or are hand held by one or more operators to pry loose vegetation, preferably with the least amount of effort. The hand held line filament and bladed landscaping trade is further divided into grounds level tools, grounds accessible tools and grounds elevated tools.

Hand held grounds tools have a forward tool output arm and a rearward control input arm that form a boom with several fulcrum point options. The rearward control arm generally has a front control handle and a power control handle shaped into a handlebar with a first order fulcrum pairing. There are many grounds maintenance advantages and disadvantages based on where the handlebar is located on the yard tool. Grounds accessible tools chiefly position the grounds tool fulcrum near the front control handle to create greater tool pivoting arc advantages for easy access to plant foliage. The main disadvantage of the first order grounds tool is that the thin profile tool output arm could bend or become blunt if pivoted or hurled into the ground. The first order fulcrum is an advantage for positioning the operator away from horizontal line filament and bladed tool instruments. The grounds level tool is converted to a second order fulcrum position when adding a skid element or suspension to the output arm. The third order fulcrum is located near the rearward control arm end as an advantage to hold grounds elevated tools in near vertical positions. Some larger third order grounds elevated equipment becomes a disadvantage to hold in cantilever positions. Accordingly, grounds maintenance exercises with twelve feet or more of third order boom reach is usually left to professionals that routinely manage projects with compound arm support machines.

Line filament grounds tools have a time saving advantage when operated in multiple trimming planes. However, orbital line filament trimming tends to become more difficult as the grounds tool boom moves or bends away from its intended target. Compact pre-orthogonal fold line filament trimming could also become a worrisome disadvantage for grounds maintenance operators. Compact line filament cutting techniques, that is, oblique grounds trimming exercises encourages the operator to choose other grip alternatives on the boom, the operator is more likely to remove the operator shield from the output arm as a quick fix to correct a pre-orthogonal trimming angle, an oblique cutting angle can significantly increase flying projectiles and a skewed cutting head is difficult for predicting disturbances which could squander energy.

Fuel powered hand held grounds level tools are built with the motor initially positioned behind the operator. The fuel powered grounds level tool can have a second order wheel attached near the output arm end to constrain line filament tool bending or to dampen impact during bladed tool soil penetrating efforts. The tool output arm working end energy savings has significant advantage to send less grounds disturbance response back towards the operator. There are visible signs of grounds tool energy waste. For instance, U.S. Pat. No. 6,240,644 B1 ('644) has the operator holding the fuel motor assembly upside down in the reversed power control handle position for vertical grounds trimming. The '644 smaller motor input arm appears to be driving the longer tool output arm, at speeds sometimes reaching 8,500 rpm, which is a disadvantage for supporting thin and flexible line filament. The '644 grounds tool is directed in a third order vertical trimming position typically over hard pavement that could strain the operator, perhaps about five times greater than tool response from regular turf trimming functions. The '644 vertical grounds trimming exercise raises the motor assembly. Accordingly, the motor assembly of '644 is drawn towards breathing, viewing, skin and hearing passages while some EPA reports still suggest that fuel powered motors need to remain behind the grounds operator. Furthermore, the '644 invention flips the fuel tank over to possibly spill harmful liquids onto the operator. The '644 invention shows the line filament tool leading tip being exposed towards the operator during vertical trimming operations which is usually a mess and is possibly unsafe. The '644 operator must turn their head sideways to more often view the vertical trimming operations from an aching neck position that also tends to hide upcoming objects during grounds operations. Fuel consuming grounds tools are critical for hand held use after storms, fires and even bombs have knocked out portions of the US electric power grid which means that current fuel regulations need to focus on a grounds tool path of least resistance instead of adapting policies that put the American Outdoor Power Tool Industry in short supply.

Electric grounds tool use is appealing to residential end users because power cords and batteries are rarely known to emit gas fumes, but electric power does tend to generate and store heat current that could be more dangerous when stowed near fuel powered systems. The electric grounds tool will generally have a fulcrum where the forward control handle separates the power control input arm from the tool output arm so that the motor can accompany the output arm. U.S. Pat. No. 6,581,246 B1 ('246) consists of an adjustable front control handle that is mounted onto the boom fulcrum in the first order. However, the '246 power control handle position causes the operator fulcrum to move in front of the operator in a third order footing position which is a weakness for holding the grounds tool intact. The '246 operable line filament head can suddenly pivot back into the operator when the rearward power control handle is suddenly dislodged by the operator. The '246 adjustable front control handle is burdensome to manufacture, difficult to hold and hard to adjust for active line filament grounds tool operations. An operator will pull the '246 standard power control trigger substantially out of alignment when transforming the grounds tool from the horizontal trimming plane to a vertical trimming plane. Besides, the operator may injure their hand knuckles trying to pivot the '246 adjustable front control handle beyond the boom ninety degree longitudinal fold for accurate vertical grounds trimming. It is also risky for the operator to pivot the '246 adjustable front control handle forward since the technique increases the chances of the operator coming in contact with line filament tool. The '246 forward control handle can be folded into an upside down position for vertical line filament grounds trimming, thus forcing the operator to grab onto the boom for a more comfortable holding position. Instead of making tiresome tool adjustments to the front control handle, some operators of '246 will grab onto the boom which leads to fatigue from weaker ergonomic controls of the tool output arm. The '246 adjustable Y shape handle grip can be substituted with an adjustable D handle for horizontal and vertical line filament trimming. The popular D handle produces considerable flaw during vertical grounds trimming operation that may result in the same difficulties as '246.

Bladed grounds tools are usually limited to a single operating plane unless the bladed tool has a childproof bladed fan shield, if there is a shut off for sudden upward chainsaw type pivot motion, there is an exception for elevated tools maintaining a reasonable vertical distance away from the operator and the rotation of reciprocal bladed tools inhibits finger entry. Brush cutters have sharp rotary blades that will pivot laterally while moving forward relative to the boom transport direction, as described in U.S. Pat. No. 6,745,475 B1 ('475). The '475 first order bull horn handlebar is superior for controlling lateral grounds work. A shoulder harness must be worn by the operator to help support the brush cutter vertical response. Lateral barrier bars are sometimes added to D handles as a substitute for the '475 bull horn handlebar to control the grounds tool kickback. The '475 third order brush cutter can accidentally tilt into grounds material and become dull because it is difficult to roll a wheel suspension over stubby vegetation. The '475 brush cutting blade needs regular sharpening and is often replaced to reduce grounds resistance response which is why automatic feed line filament tool operation has gained momentum in the US. The '475 brush cutter has a danger cutting zone nearest to the northeast radian part of the cutting disk. More specifically, the '475 invention is designed to cut through thick brush in a strict horizontal northwest radian direction which crosses the forward transport route of the operator. The '475 bull horn handle is transverse to the longitudinal boom which poses a disadvantage when the operator walks along difficult terrain. The '475 operator could pull back on the bull horn handle while falling back on a slope which could cause a guillotine response. The '475 operator may have a hand injury by pushing forward on the handlebar when attempting to regain footing down a slope. Therefore, it is possible that the '475 bull horn handlebar could be moved comfortably about twenty degrees to a left offset cutting position to habitually guide the brush cutting blade away from the forward transport path and in a place where less bladed tool momentum is created. Manual hand tools can be used on slopes instead of brush cutters to slow down the work load, but infrequent manual grounds maintenance is sometimes a risk for back injuries.

Hedge trimming tools and chainsaws make practical grounds accessible tools because the tool trimming plane folds on the boom line of symmetry. Accordingly, the accessible tool working end will match the forward control handle turns for about every one and one-half degrees of offset grounds level tool handling. A larger hedge trimmer arc improves reciprocal blade alignment with circular shaped bush foliage. Therefore, an operator has less jeopardy of inadvertently reaching towards the active hedge trimming danger zone to pull on awkward to cut plant shoots when the hedge trimmer front control handle has a wheel shape. U.S. Pat. No. 6,178,642 B1 ('642) facilitates a D handle that limits grounds accessible tool trimming to left and right square angles that could become unsafe for operators.

Accessable chainsaws are the exception for large folding arcs because only a wedge cut between ninety degrees is needed to professionally clear mammoth or small trees. U.S. Pat. No. 4,202,096 ('096) is a chainsaw that has prevented many grounds accessible tool injuries by restricting the forward tool handle to a ninety degree fold, but U.S. Pat. No. 5,272,813 ('813) may provide a slightly thicker chain bite which has a faster wood chip cooling response. The chain cooling response generally allows for more reasonable sharpening of blades to minimize stagnant heat in forest type settings for less fatigue to an operator caused by thinner chain tip dulling and weak air conditioning power. Overall, a larger '813 chain can be sharpened more often and vibrate less than a thinner chain of the same length.

Third order elevated power pole pruning saws are usually held up about twelve feet in the air to trim overhanging limbs that interfere with mowing operations. The advantage of pole pruning is to pry loose tree limbs without having to use unsafe ladders and other risky compound structures. U.S. Pat. No. 4,999,917 ('917) is a grounds tool that provides a third order vertical trimming operating, but the '917 horizontal trimming operation is a disadvantage because the third order cantilever effort usually pulls on the forward arm of the operator. Power pruning chains, like the '813 chain, must be kept lubricated and sharp to lessen tool resistance and operator fatigue.

Hand held blowers are complimentary to line filament and bladed tool vertical trimming operations. Large blowers are either backpack or machine held whereas lightweight blowers are usually maneuvered by one hand. One of the more interesting aspects of single hand held blower use is that the first order tubular output arm has a tremendous airflow response disadvantage for twisting the hand of an operator. Accordingly, the grounds operator can switch from an opposing grounds trimmer hand grip to an opposite hand position for blowing debris back into yard interiors or add a front wheel suspension to the outlet arm wand since most blower grounds work is completed over smooth surfaces.

Some inventions combine trimming and blowing functions into one transport operation. U.S. Pat. No. 7,047,592 ('592) combines a constant fan operation with occasional trimming work. An operator would have a difficult time controlling the '592 vertical trimming and blowing operating positions because it is obvious that prior art control handle effort would be difficult in supporting the extra load put on the bent output arm. The '592 invention doesn't suspend the tool operation in equilibrium for vertical trimming. The '592 grounds tool weight forces the manufacturer to shorten the output arm which brings the trimming plane closer to an operator. The '592 horizontal operation is impractical because interior yard horizontal trimming rarely requires the weight of an outer yard perimeter blower. The '592 blowing and trimming operations are entirely dissimilar because the blower and line filament tool vertical operations are extremely hard to balance along common grounds edging routes which could become more than four times the grounds maintenance effort when transport fatigue is added into all of the tool disturbances. It would take enormous time and effort to fold the '592 ground tool into reciprocal trimming positions after each vertical and horizontal trimming chore, and a welcomed harness application would only make the grueling '592 process take longer. Furthermore, '592 includes a weighted blower air inlet cover that substantially increases fuel consumption because the fan inside the blower continues to spin during trimming chores. The '592 trimmer and blower weights are more likely to disturb line filament motion in the vertical trimming position and has greater opportunity to scalp lawns in the horizontal trimming position.

U.S. Pat. No. 4,463,498 addressed boom mid-section multi-task functions, but splitting a drive shaft in half adds unnecessary vibration response from the grounds operation to the operator. The '498 front handle requires additional interchange steps with different grounds tool attachments and the tool is substantially out of equilibrium after the flawed ninety degree mid-section shaft button is adjusted for vertical lawn edging. Additionally, the '498 handle bracket must be readjusted after each grounds tool activity that some landscapers prefer to bypass. The '498 front control grip is kept in the same position during tool folds which can send enormous grounds resistance back to the operator. Furthermore, '498 doesn't offer a front suspension alternative for its orbital line filament operations to control line filament tool resistance.

Grounds maintenance injuries are known to be prevented with increased use of operator shields. A properly aligned operator shield will have approximately eighty degrees or more of radial protection towards a rearward right or left handed grounds tool boom operation. Well built operator shields will approximately hug working surfaces with respect to the operator having a reasonable view of the tool to control scalping of vegetation. Attempts have been made to tuck structural frames beneath operator shield covers, but this tends to gather debris and increase tool loads. Operator shields can be safely vented at a proximal end which opens airflow and reduces line filament resistance.

Tree problems may occur from line filament and bladed grounds tool nip damage. Grounds tool nip damage opens up grooves in tree bark where pests like to fester. Potential damage to trees and other objects can be averted by aligning a second order front wheel suspension in proximity to a horizontal line filament outer working tip. A front suspension is an advantage for minimizing wear to objects like fence posts. A front suspension is also critical for relieving response pressure on drive parts and for relieving stress to the operator. A front suspension can be quickly installed or removed from a grounds level tool to reduce weight during long term field trimming operations. A featherlike front wheel suspension will save enormous energy during horizontal and vertical hand trimming operations.

This application attempts to overcome some of the shortcomings associated with grounds tool prior art by orientating hand held grounds tools and operators on a path of least resistance.

### BRIEF SUMMARY OF THE INVENTION

The primary object of the invention is to provide an operator with an upright input arm that has a first control grip that is substantially balanced on a boom line of symmetry by a line filament and bladed tool output arm load that has a second control grip.

A further object of the invention is to provide the grounds tool with transposable grips when needed to position the line filament and bladed tool and the operator on a path of least resistance.

Another object of the invention is to provide the grounds tool with practical means for assembly and removal of tool attachments.

Another object of the invention is to provide the grounds tool with a motor assembly with less potential harm to the operator and the environment.

A further object of the invention is to provide the grounds tool with various height adjustments that fit comfortably to right or left handed end user.

Yet another object of the invention is to provide the grounds tool with consistent motor input power control to the line filament and bladed tools.

Still yet another object of the invention is to provide the grounds tool with control grips that compliment the line filament and bladed tools.

Another object of the invention is to provide the control grips with a simple barrier bar alternative and operative grip lock down to uphold tool safety standards.

A further object of the invention is to provide the control grips with ergonomically transposed holding positions.

Yet another object of the invention is to provide the grounds tool with the same forward tool transport route in all frontal tool operations for safekeeping.

Another object of the invention is to provide the control grips for improving sound tone magnitudes by keeping exhaust response behind the transport path.

Another object of the invention is to provide the control grips with longitudinal separation to prevent injury to operators.

Yet another object of the invention is to provide the grounds tool with a front suspension for reducing resistance and line filament and bladed tool kickback.

Still yet another object of the invention is to provide the front suspension to maneuver around oncoming objects without harm.

Another object of the invention is to provide the front suspension to maneuver over loose and soft grounds surfaces.

Another object of the invention is to provide the front suspension for a straighter horizontal, rounded or vertical cut to reduce stress and watering of vegetation.

A further object of the invention is to provide the grounds tool with consistent lubricant films on fast moving parts.

Yet another object of the invention is to provide the grounds tool with an aerodynamic operator shield that is vented to prevent suction of debris and vegetation.

Still yet another object of the invention is to provide the operator shield with radian walls that align opposite of the front suspension to help balance the yard tool.

Another object of the invention is to provide the operator shield and front suspension for protecting an operator and oncoming property simultaneously.

Another object of the invention is to provide the grounds tool with a tool shield that has an open fan to disperse debris away from line filament and bladed tools.

A further object of the invention is to provide the grounds tool with less weight when detachable parts are unneeded.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a grounds tool with transposable grips comprising: a boom having an input arm and an output arm, a motor connected to the input arm or the output arm to drive a line filament tool or a bladed tool at the output arm forward working end, the drive system having means to divide into flexible or linear segments on the boom line of symmetry, the input arm including a first control grip maintaining operative upright relations about earth's origin, the first control grip having an upper track that longitudinally treks from a socket chamber opening to an upper mid-slot, the upper mid-slot further circumferentially linked to two lower mirrored slots, the mirrored slots further linked from a lower double track back to the socket chamber opening, the output arm comprising a second control grip, the second control grip positioned transverse on the boom line of symmetry, the second control grip further positioned between the tool working end and a button or a dual-button coupler end of the output arm, a fulcrum is determined on the boom in the second control grip hand operator holding position whereof the motor is mounted to the output arm, the fulcrum is determined on the boom between the first and second control grips operator holding positions whereof the motor is mounted to the input arm and the fulcrum is determined on the boom at the tool end whereof the tool working end is held up by a front suspension and the boom is held up by the operator, the button coupler having means to pass through the upper track to engage the mid-slot where the engagement forms a translation lock and a transpose lock on the boom from which the first control grip central position is at least ten inches away from the second control grip transposed upright central position, the dual button having means to pass through the lower track to engage the mirrored slots where the engagement forms a translation lock and a rotation lock on the boom from which the first control grip central position is at least ten inches away from the second control grip upright central position, the mirrored slots include a recess for an outside device to pry the button or the dual button loose to decouple the input arm from the output arm, the tool bracket having means for tangential line filament and bladed tools, the rotation lock compresses forming a rigid boom, the second control grip having means to transpose a third grip, the second control grip having means to transpose a forth grip, the tools left and right isometry folds are congruent with the left and right mirrored slots isometry folds and the control grips transposes, the second control grip having barrier bar means from the left side of the boom facing the tool kickback zone, an operator reverse hand grip transposes the first and second control grips longitudinal isometry folds away from the tool working end congruent isometry folds, an operator overhand grip transposes the first and second control grips lateral isometry folds away from the tool working end congruent isometry folds, the second control grip free to maintain the input arm elements in operative upright positions, the first control grip having means to branch off with respect to the second control grip maintaining the grounds tool equilibrium from an opposite holding position, the first and second control grips free from collapsing towards the tool end, the first and second control grips having means to transpose congruently with the right and left mirrored slots, the tool bracket having tool shield means, the boom and tool bracket having operator shield means, the operator shield having radian walls at least about twice the boom operative tilt, the boom and tool bracket having means for a front suspension orientated parallel to the tools tangential planes, the front suspension complimentary and supplementary to the operator shield radian walls, the front suspension having wheel means, the front suspension having dynamic reducing means, the wheel having horizontal means for separating oncoming objects from the line filament and bladed tools, the wheel having vertical means for supporting, rolling and hovering the yard tool over grounds surfaces, the tool bracket having chamber means, the chamber having means to duplicate, reciprocate or reverse the tools tangential motions, the chamber cooled with uniform ambient airflow, the chamber having uniform pressure on lubricants, the chamber having open and uniform fan means, means for a fifth grip positioned on the boom, the fifth grip having means to translate the motor between the tools in the tool and the motor idle speeds, the motor produces less than two-hundred rpm input power variance with respect to the tool output responding to equal or matching grounds resistance.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated, scaled smaller or enlarged to facilitate an understanding of the invention.

FIG. 1 is a perspective view of the invention illustrating the grounds tool being held up by auxiliary input and output arms to maneuver a line filament or bladed tool in a horizontal grounds maintenance position.

FIG. 2a is a partial top view of FIG. 1 illustrating the auxiliary input arm detached from a button of the auxiliary output arm embodiment of the invention, the FIG. 2a illustration includes a cut out view of the mid-slot linkage of the translation lock to the single track.

FIG. 2b is a partial bottom view of FIG. 2a illustrating an input arm embodiment of the invention, the FIG. 2b illustration includes a cut out view of the lower twin tracks.

FIG. 3a is a partial perspective view of FIG. 2 illustrating an auxiliary second control grip embodiment of the invention.

FIG. 3b is a partial side view of FIG. 2 illustrating one of many fastening alternatives for the second control grip to the output arm (not shown) embodiment of the invention

FIG. 4a is a smaller perspective view of FIG. 3a.

FIG. 4b is a perspective view embodiment of the invention illustrating an auxiliary barrier bar embodiment of the invention.

FIG. 4c is a perspective view embodiment of the invention illustrating an auxiliary third control grip embodiment of the invention.

FIG. 4d is a perspective view embodiment of the invention illustrating an auxiliary forth control grip embodiment of the invention.

FIG. 5 is a perspective view of FIG. 4a and FIG. 4c illustrating an auxiliary single spoke and single yoke clip transposable grip mountings embodiment of the invention.

FIG. 6 is a perspective view of FIG. 4a and FIG. 4d illustrating auxiliary left and right mirrored lateral transposable grips and the second control grip embodiment of the invention.

FIG. 7 is a perspective view of FIG. 4a and FIG. 4b illustrating the barrier bar lateral coupling of the second control grip.

FIG. 8 is a partial split perspective view of FIG. 2 illustrating an auxiliary fifth control grip embodiment of the invention.

FIG. 9a is a side view illustrating the transposable grips maintaining transverse relations over the input arm embodiment of the invention.

FIG. 9b is a perspective view of FIG. 9a illustrating the transposable grips maintaining transverse relations over the input arm embodiment of the invention.

FIG. 10 is an exploded perspective view of an auxiliary fan embodiment of the invention, FIG. 10 further shows an auxiliary front wheel suspension embodiment of the invention.

FIG. 11 is a partial top view of FIG. 1 illustrating the auxiliary line filament string trimmer output arm embodiment of the invention that can be coupled to and assisted from the input arm, FIG. 11 includes an auxiliary operator shield and an auxiliary front wheel suspension embodiment of the invention that can assist the input arm.

FIG. 12a is a partial perspective view of FIG. 1 illustrating an auxiliary single reciprocal blade hedge trimmer output arm embodiment of the invention that can be coupled to and assisted from the input arm.

FIG. 12b is a partial bottom view of FIG. 12a illustrating an auxiliary dual button embodiment of the invention.

FIG. 12c is a partial perspective view of FIG. 1 illustrating an auxiliary dual reciprocal blade hedge trimmer output arm embodiment of the invention that can be coupled to and assisted from the input arm.

FIG. 12d is a partial top view of FIG. 12c illustrating an auxiliary dual button embodiment of the invention.

FIG. 13a is a partial perspective view of FIG. 1 illustrating an auxiliary pole pruning output arm embodiment of the invention that can be coupled to and assisted from the input arm.

FIG. 13b is a partial bottom view of FIG. 13a illustrating the dual button embodiment of the invention.

FIG. 13c is a partial top view of FIG. 13a illustrating the button embodiment of the invention.

FIG. 14a is a partial perspective view of FIG. 1 illustrating an auxiliary blower embodiment of the invention assisted in a right diagonal wand position.

FIG. 14b is a partial perspective view of FIG. 14a illustrating the auxiliary blower embodiment of the invention assisted in a left diagonal wand position.

FIG. 15a is a partial perspective view of FIG. 1 embodiment of the invention illustrating an auxiliary brush cutter output arm embodiment of the invention that can be coupled to and assisted from the input arm.

FIG. 15b is a partial bottom view of FIG. 15a embodiment of the invention illustrating the auxiliary dual button of the output arm.

FIG. 16a is a partial perspective view of FIG. 1 embodiment of the invention illustrating a bladed lawn edging attachment for the input arm.

FIG. 16b is a partial bottom view of FIG. 16a embodiment of the invention illustrating the auxiliary dual button of the output arm.

FIG. 17 is a partial perspective view of FIG. 1 illustrating an auxiliary line filament and blower output arm embodiment of the invention that can be coupled to and assisted from the input arm.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

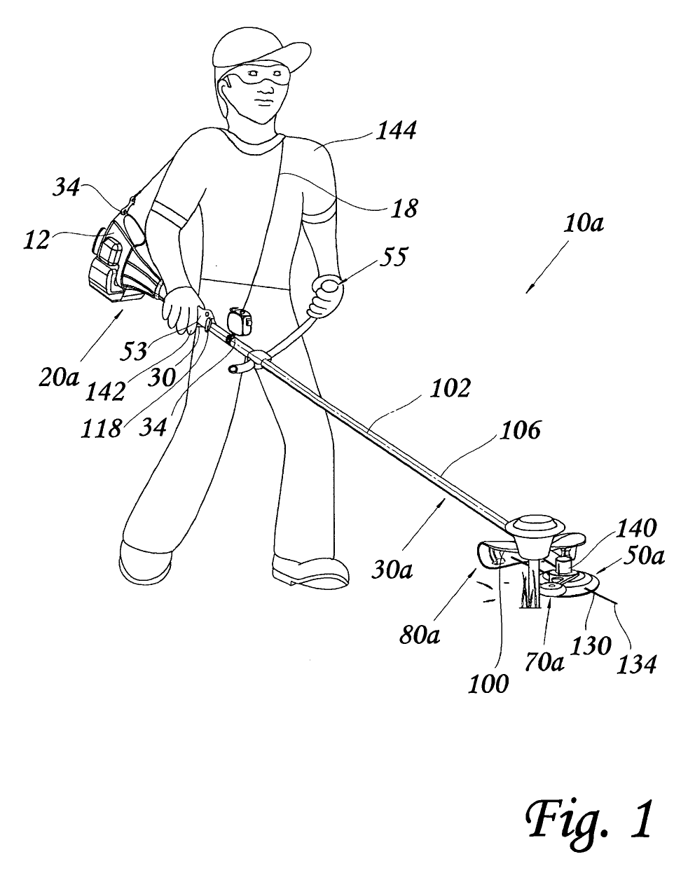

Referring to FIG. 1, the grounds tool 10a is shown comprising a boom 102 having a straight shaft 106 connection of an input arm 20a to an output arm 30a. A string trimmer of the line filament 130 tool 50a type is mounted to the output arm 30a tool bracket 140. The input arm 20a having a first control grip 53 and a motor 12 maintaining operative upright relations about earth's origin with respect to the line filament 130 tool 50a orbital trimming planes. The output arm 106 has a second control grip 30a that is centrally positioned between the tool 50a working end and the input arm 20a at least ten inches away from the from the first control grip 53 center. The first 20a and second 30a control grips can maneuver the tool 50a working planes within mirrored single isometry positions. The operator 144 may want to alternate their index finger 142 from the first control grip 53 trigger 30 position to the second control grip position 55 to balance resistance response from the tools 40a after each grounds tool 10a cycle by clamping or transposing the second control grip 55 to the opposite side of the boom 102. The second control grip 40a can be laterally or longitudinally folded into one or more transposable grips free of collapsing while the first control grip 30a is reversing into the upright position.

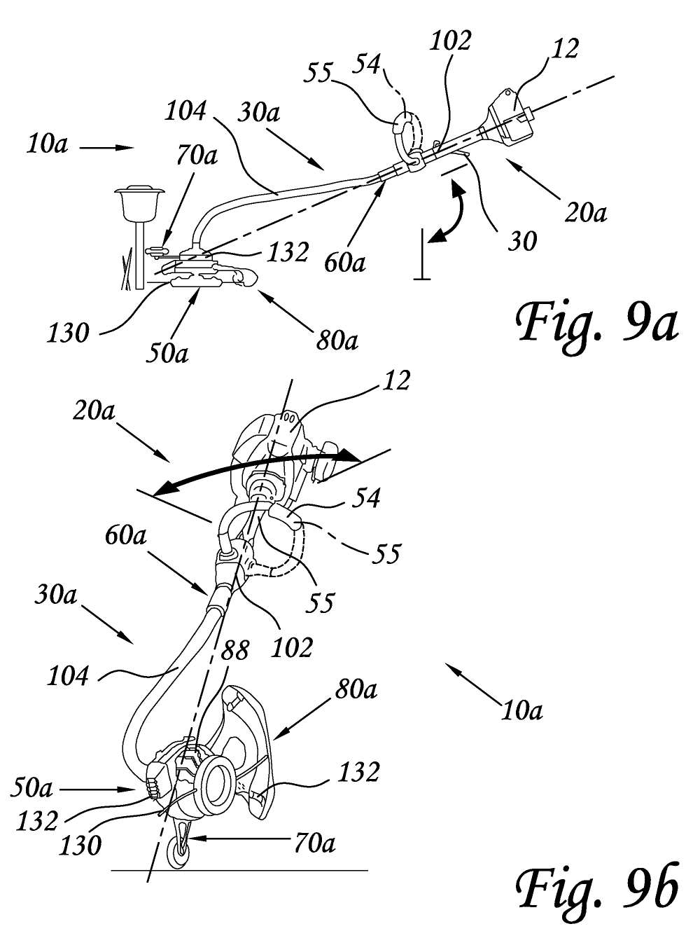

Referring to FIG. 1-FIG. 2b and FIG. 9b, the tools 50a are driven by a drive shaft 38 which is sometimes straight 106 from the motor 12 to the tool 50a end, but the drive shaft 38 and boom 102 can flex into a bow shaft 104 shape and separate into one or more segments. The output arm 30a passes through a socket 90 chamber of the input arm 20a and couples to a translation lock 120, then the input arm 20a is clamped down to the output arm 30a by a rotation lock 118 that holds the boom 102 in a more rigid position. The input arm 20a positions the motor 12 behind the operator 144, as described in FIG. 1, which approximates the grounds tool 10a fulcrum between the first 53 and second 55 control grips whereas a front suspension 70a, as viewed in FIG. 9a, will shift the yard tool 10a fulcrum to the tool 50a end which is a substantial advantage for dampening the line filament 130 material along hard pavement. The boom 102 and tool bracket 140 provide several engineering options for mounting an operator shield 80a with radian sidewalls 100 at least about twice the boom 102 operative tilt angle. The operator shield 80a radian sidewalls 100 are complimentary and supplementary to an auxiliary front suspension 70a. The featherlike front suspension 70a is about two and one-quarter percent of the grounds tool 10a weight.

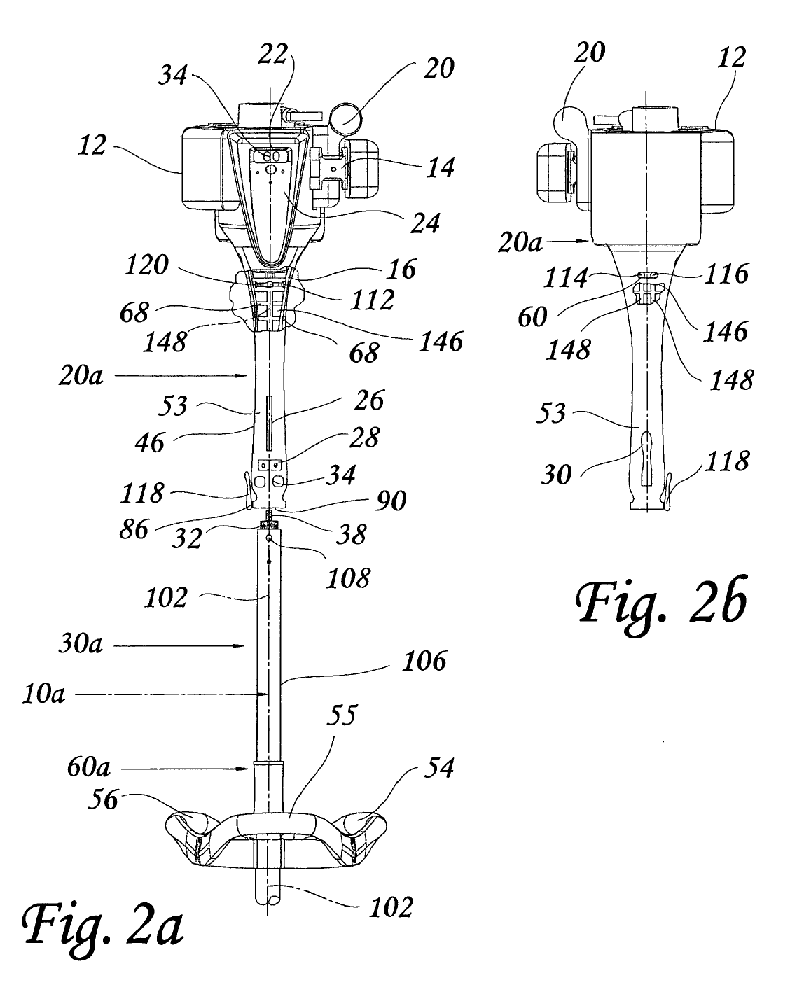

Still referring to FIG. 1-FIG. 2b, the motor 12 is mounted at the input arm 20a rear distal end for restricting power emissions from near an operator's 144 seeing, hearing and breathing passages. The motor 12 and input arm 20a mounting is also designed to reduce accidental leaks from the power source 20, but the motor 12 can be mounted elsewhere on the boom 102. For example, the motor 12 can be located on the output arm 20a to achieve equilibrium balance for the grounds tool 20a at the second control grip 53 which ultimately converts grounds chores into third order cantilever operations from the operator 144 transport end to the tool 50a working end. Therefore, the front suspension 70a is preferred for changing many cantilever output arm 30a motor 12 configurations to more stable second order ground positions.

Referring further to FIG. 2a-FIG. 2b, the longitudinal socket 90 supplies an upper track 148 that longitudinally treks from the socket 90 chamber opening to an upper mid-slot 116 that is further circumferentially linked to two lower left 112 and right 114 mirrored slots and a lower double track 150 that trek back to the socket chamber 90 opening. The socket 90 further provides evenly spaced concentric rings 68 with an ability to dampen the tool 50a grounds responses. The top 148 and lower 150 tracks are needed to prevent the button 108 and dual button 110 from getting hung up on the dynamic reducers 68. A rotation lock 118 on the input arm 20a will adjust into an open position to permit a button 108, near the output arm 30a shaft 106 coupler end, to compress through the longitudinal socket 90 and stay in the upper track 148 until the button 108 engages the mid-slot 116 wherein the boom 102 can be held together by the translation lock 120 and circumferentially fold to one of the lower left 112 or right 114 mirrored slots. The button 108 reverses the input arm 20a and output arm 30a elements into congruent opposite single isometry folds (a path of least resistance.) On the other hand, the dual button 110 locks the input arm 20a and output arm 30a elements together on the boom 102 line of symmetry. The translation lock 120 engagement of the button 108 or the dual button 110 prevents the boom 102 from separation. The second control grip 55 will transpose into a third control grip 54 or a forth control grip 56 only when the button 108 engages the translation lock 120. Compressing the rotation lock 118 cam 86 into a closed position prevents the translation lock 120 and button 108 from rotating. The rotation lock 118 cam 86 is released in an open position for the button 108 to fold between the left 114 and right 116 mirrored slot positions and to interchange tools 50a. One or more thumb activated ring clamps or nut and bolt fasteners (not shown) can be substituted for the rotation 118 and translation 120 fasteners, but the preferred cam 86 and slot embodiment can be adjusted to structurally tighten the boom 102 consistently and rapidly. The input arm 20a has an aperture 60 aligning with the left 112 and right 114 mirrored slots that will compress the button 108 or dual button 110 to release the output arm 30a safely out of the input arm 20a longitudinal socket 90 when the grounds tool 10a is positioned on a flat surface and the motor 12 is inoperable. The aperture 60 can be moved to other input arm 20a locations. It is preferred, but not essential, to secure the boom 102 using the rotation lock 118 and the translation 120 lock embodiment. In most cases, the input arm 20a can span or loop an auxiliary harness 18 into one or more upright harness clip fittings 34 to reduce line filament and bladed tool 50a response during the grounds tool 10a transport operation. The auxiliary harness 18 can be simultaneously worn and hand adjusted or kept off the grounds tool 10a

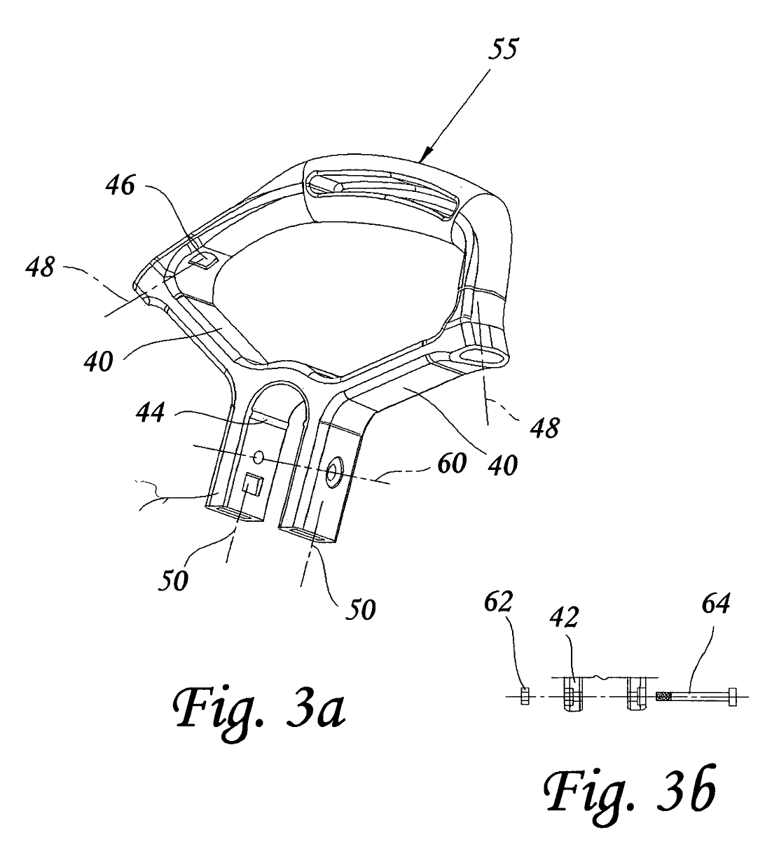

Referring to FIG. 2a-FIG. 9b, the boom 102 is separated by pulling rearward on the first control grip 53 and pushing forward on a second control grip 55. The tubular first control grip 53 scales at least ten inches apart from the second control grip 55 with respect to the grips centers being measured from a central point on the boom 102. The first control grip 30a consists of an ample power cable 16 length extending from the trigger control 30 to the motor 12. The first control grip 53 provides the operator 144 with consistent right and left index finger 142 actuation means on the trigger control 30 with respect to the tools 50a folding into left and right single isometry folds. In addition, activating the trigger control 30 from the same grip position allows the operator 144 to focus more on the tools 50a from a left or right boom 102 holding position. To add more comfort, the first control grip 53 may provide one or more dampener 36 layers. The second control grip 55, as shown in FIG. 3a, is primarily used when the mirrored slots are engaged by the dual button for single plane bladed 132 tool 50a grounds operations. The second control grip 55 is centered upright over the boom 102 for strict tool 50a plane operation. The second control grip 55 bows to one or more spokes 40, but the second control grip 55 can be straight. It is preferred, but not essential, that the spokes 40 project downwardly from a recess clip fitting 46 to a simple nut 62 and bolt 64 yoke 42 type lateral clamping application or a more elaborate longitudinal clamping gearbox embodiment, as generally described in FIG. 9a and FIG. 9b. The yoke 42 has one or more inner lips 44 or like kind lips to structurally hold the second control grip 55 onto the boom 102. The second control grip 55 is separated from the yoke 42 for a standard large winter glove to fit through. The yoke 42 is mounted onto the boom 106 in the offset way for simple hand or tool fastening applications without interference from the second control grip 55. Therefore, the yoke 42 offset prevents the second control grip 55 and fist movements from a multiple of nut 62 and bolt 64 fastening or the like fastening obstructions. The yoke 42 offset further allows the second control grip 55 to lean forward on the boom 106 or mirror in an opposite axial direction to regulate transport speeds of different stride operators. The second control grip 55 has means for one or more dampeners 68. It is preferred, but not essential, that one or more outside and inside recess fittings 40 be located at the opposite end of the spokes 40 to house additional second control grip 55 attachments.

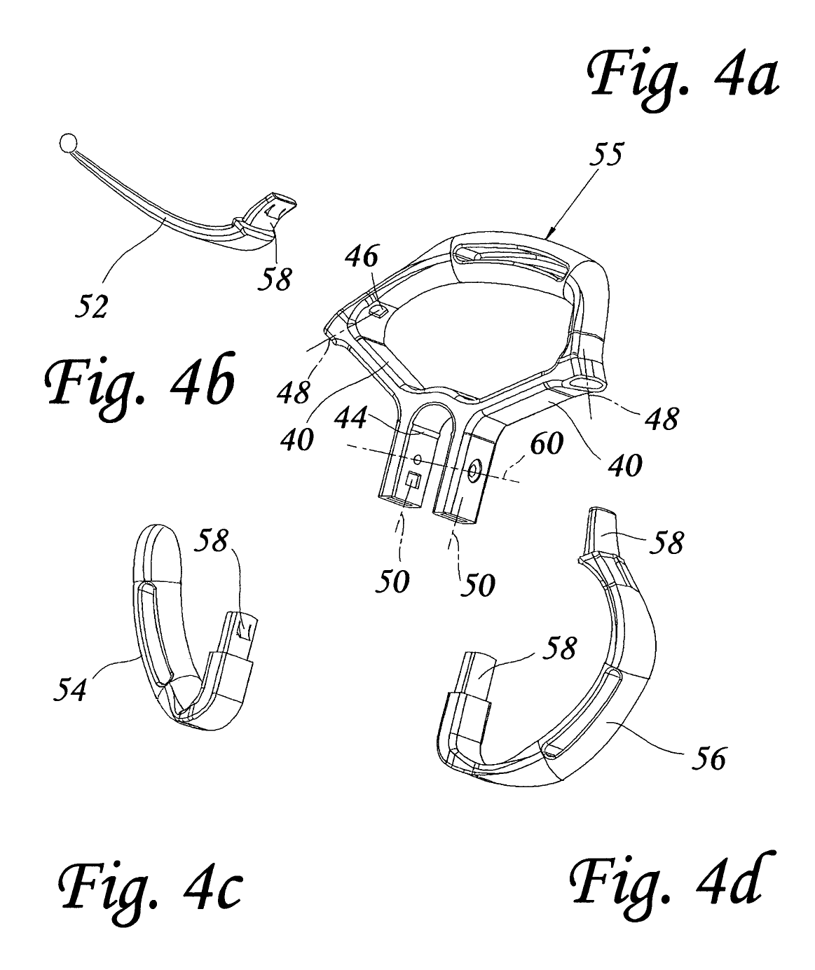

Referring specifically to FIG. 4a-FIG. 4d and additionally to FIG. 2a, the second control grip 55 includes a barrier bar 52 alternative embodiment that can be attached to the second control grip 55 in a fixed lateral position facing the tool 50a kickback direction. If preferred, a third control grip 54, as described in FIG. 4c, is molded with one or more clips 58 that mount from a proximal end within one of the second control grip 40a outer recesses 48 for reducing weight or increasing structural leverage of the boom 102, though the third control grip 54 can be formed into a forth 56 control grip that has one or more clips 58 capable of fastening to the second control grip 55 outer 48 and inner 50 recess fittings for a more rigid hand grip, as observed in FIG. 4d. It is important to note that the barrier bar 52, the third control grip 54 and the forth control grip 56 can be mounted onto the boom 102 or the second control grip 55 by other clamping means to produce the alternative embodiments. The third 54 and forth 56 control grips are made at least about four inches wide to guide the operative fixed line filament 130 and reciprocal bladed 132 tools 50a with appropriate or standard handle control.

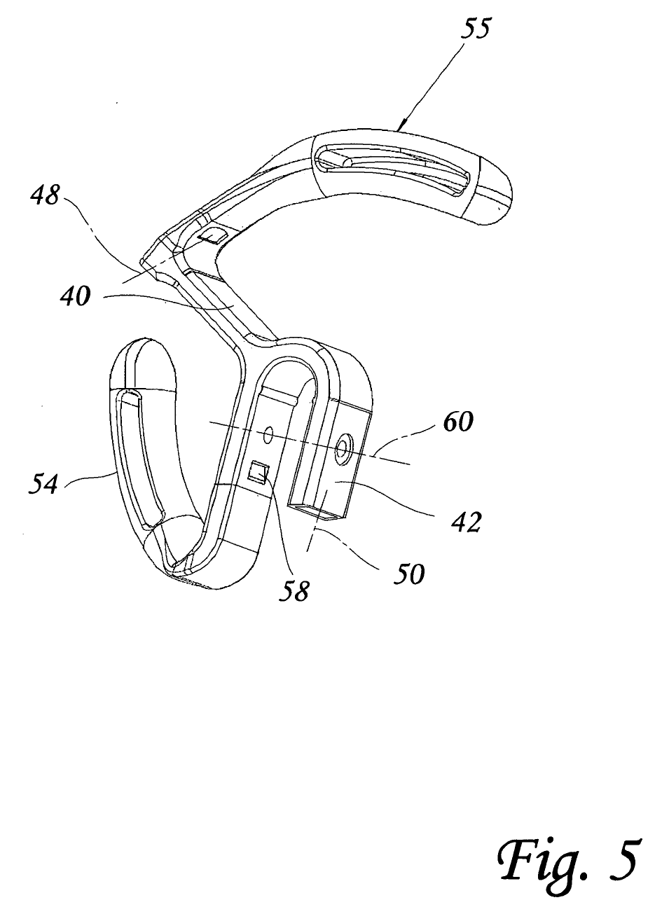

Referring now to FIG. 5 and FIG. 1, the second control grip 55 sometimes has a single spoke 40 embodiment. In this case, the third grip 54 can interchange with either inner recess 50 or with the outer recess 48 and the yoke 42 can be clamped to either side of the output arm 30a for a plurality of control grip options. The single clip 58 assembly of the third control grip 54 to the single spoke 40 second control grip 55, as described in FIG. 5, is ideal for balancing asymmetrical grounds tools 10a and can switch to either side of the boom 102 for tool 50a leveling purposes.

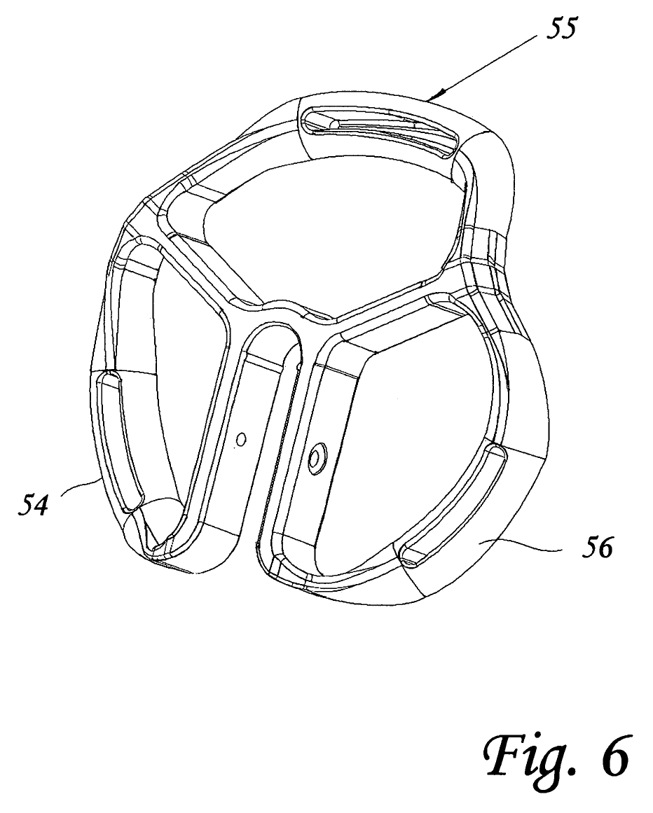

Referring to FIG. 6, FIG. 9a-9b and to FIG. 1, the upright second control grip 55, viewed in FIG. 6, can transpose the third 54 or forth control grips into upright mirrored isometry positions with respect to the tools 50a congruently folding into left and right isometry folds. The forming of three transposing control grips into a pretzel shape handle distributes loads evenly and allows the operative tools 50a to wear uniformly on both sides of the leading and trailing working edge which improves the structural performance of line filament. The symmetrical third 54 and forth 56 control grips are convenient for left and right handed yard tool 10a grounds maintenance which also changes distal cutting tool 50a rotary directions for better distribution of stress on vegetation and equipment. In addition, the first 53, third 54 and forth 56 control grips can transpose the tools 50a into the vertical suspension 70a support position to lower resistance caused by hard contact or the second control grip 55 will transpose the tools 50a into the horizontal suspension to lower resistance brought on by upcoming objects, as observed in FIG. 9a-FIG. 9b. The third 54 and forth 56 control grips, as shown in FIG. 6, can be transposed onto the upright second control grip 40a congruently with the tools 50a left and right orthogonal isometries free of collapsing. It is sometimes preferred, but not essential, to make the forward transposable grip embodiment into a single loop or one mold handle.

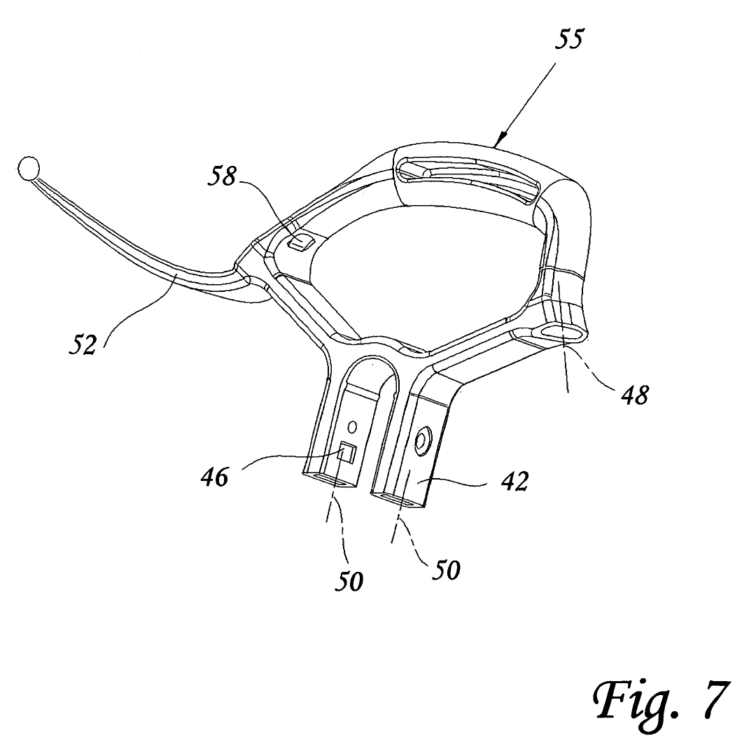

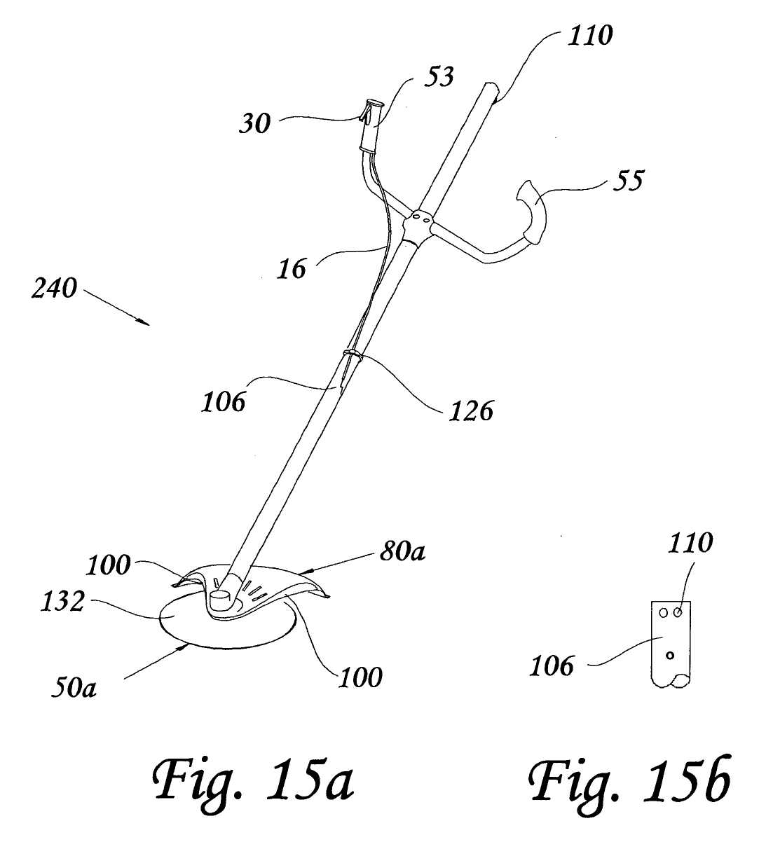

Referring to FIG. 7 and to FIG. 15a, the second control grip 55 can branch off into a lateral position whereby the barrier bar 52 interconnects to the second control grip 55 for absorbing the tool 50a rearward counterclockwise kickback motion. The barrier bar 52 will preferably have the clip 58 enter through one of the two second control grip 40a outside recesses 48 and fasten to the clip fitting 46 so that the barrier bar 52 is positioned on the left front side of the drive shaft housing 106. The barrier bar 52 can be mounted onto the boom 102 individually or put on the second control grip 55 other side as long as the barrier bar 52 remains left of the drive shaft housing 106.

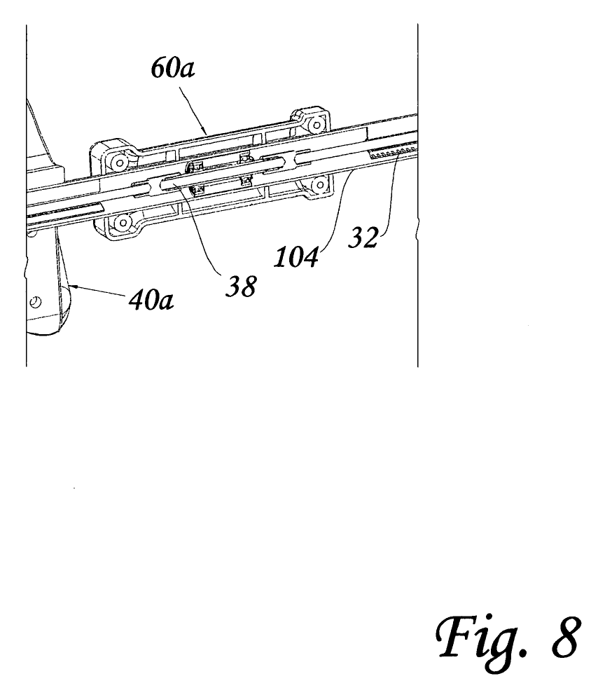

Referring to FIG. 8 and FIG. 9a, an auxiliary fifth control grip 60a can be added to the boom 102 to transfer the motor 12 input power between line filament 130 and bladed 132 tools 50a with the assistance of the drive shaft 38 cable or the like cable. The fifth control grip 60a mounts to the output arm 30a adjacent to the second control grip 55 for easy and safe usage, but the fifth control grip 60a position can be located anywhere on the boom 102. The fifth control grip 60a is gripped by the forward hand of an operator while the rearward hand of the operator is pulled off the trigger 30 to plunge the drive shaft 38 congruently between a pair of dual clam covers (not shown) to engage one of the tool 50a. The tool 50a must be in a stop position before the fifth control grip 60a can activate. The fifth control grip 60a is removable or inactive for independent line filament 130 and bladed fan 132 fan operations. The fifth control grip 60a will transmit motor 12 input power substantially free of vacuum. The motor 12 produces less than two-hundred rpm input power variance with respect to the line filament 130 and the bladed 132 tool 50a combined working output responding to equal or matching grounds resistance.

Referring to FIG. 9a-FIG. 9b, to FIG. 15b-FIG. 15b, to FIG. 6 and to FIG. 1, the combined horizontal string trimmer 130 and bladed 132 fan 88 blower embodiment transposes the second control grip 55 to the third control grip 54 congruently with tool 50a horizontal and vertical isometry transposes. The FIG. 9a-9b second 40a and third 54 control grip transpose positions are prevented from rotating towards the cutting tools 50a. The left single spoke 40 of the second control grip 55, as viewed in FIGS. 9a and 9b, is capable of moving to a right position (not shown) for congruent right isometry tool 50a folds. The forth control grip 56 can be included for bull horn handle operations and dual button 110 use, as shown later in FIG. 15a. The trigger control 30 and the first 53, second 55, third 54 and forth 56 control grips remain in the same upright transposed operative positions as the tool 50a folds in idle position. The first 30a and second 40a grips unify the transposable folds while retracting from the tools 50a. The straight shaft 106 output arm 20a embodiment, as illustrated in FIG. 1, can be a bowed shaft 104, as observed in FIG. 9a, as long as the first 53, second 55 and third 54 control grips and the tools 50a substantially align to the boom 102 line of rotational symmetry. The second control grip 55 is free from pivoting towards the tool 50a for preventing the approximate thirty-one inch stride of an operator 144 from reaching the operator shield 80a. The transposable second control grip 55 can align in opposite direction of the front suspension 70a to balance the grounds tool 10a.

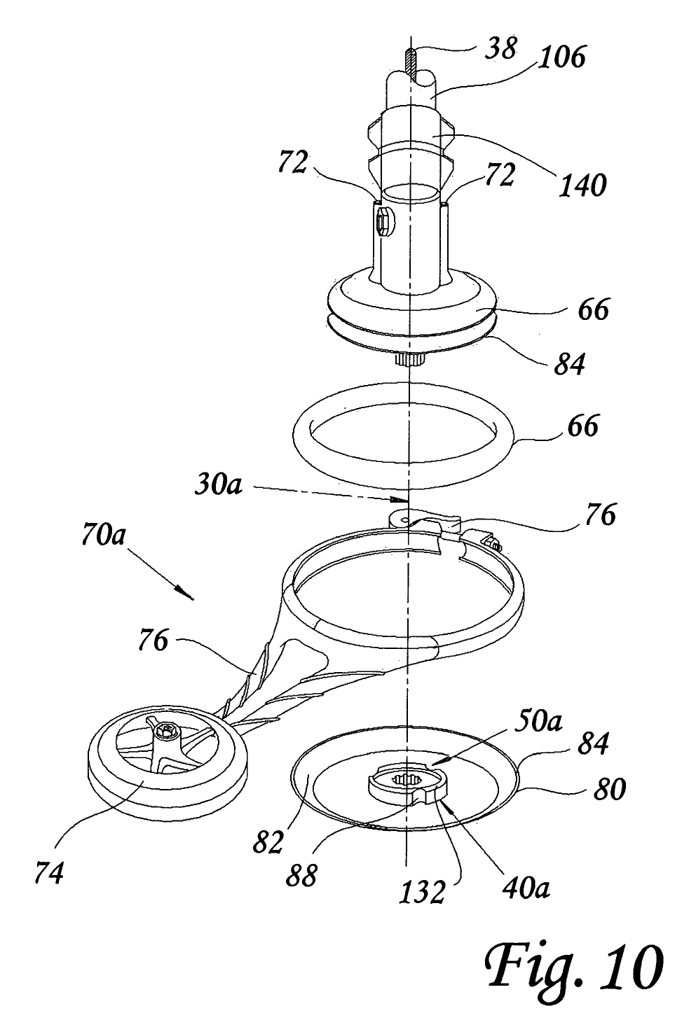

Referring to FIG. 10 and to FIG. 1, the output arm 30a mounts to a tool bracket 140 portal which preferably has screw mounting capability, but other fastener means is possible according to sound engineering judgment. The auxiliary front suspension 70a can have cam 76 clamping capability, but a simple nut and bolt type mount of the front suspension to the output arm may be used as a viable alternative. The tool bracket 140 contains a chamber 70 that can continue in the same motor input power clockwise rotary direction or has means to reciprocate, reverse and vary speeds of the tools 50a output motions. The chamber 70 is cooled with ambient and uniform airflow for consistent bonding of lubricants. The tool bracket 140 members provide means to balance the yard tool 10a, but the straight boom housing 106 sub-bracket members (not shown) will also stabilize the grounds tool 10a. A front suspension 80a is preferably mounted to the northeast radian of the tool bracket 140 since the northeast tool 50a working end 134 is a high resistance response region for horizontal cutting operations. The front suspension 70a is orientated parallel to the tools 50a tangential planes with one or more wheels 74 that support the yard tool and may be dialed to a a number of positions to balance the tool bracket 140 horizontal functions. The front suspension 70a could also be mounted elsewhere on the boom 102 to form a first order, a third order or a compound suspension. It is preferred, but not essential, that the front suspension 70a have helical wire wrapped around its frame 76 to help redirect air turbulence. The front suspension 70a can have one or more axles used as skids or have one or more wheels 74 to vertically roll over smooth hard impact surfaces. Furthermore, the front suspension 70a will horizontally spin past sensitive property objects with minimal impact to the tool 50a, the objects or the operator 144. Indeed, the line filament 130 tool 50a is prevented from bending on a trimming path of least resistance. The tool bracket 140 has a tool shield 80 which may include a small fan 88 embodiment of the bladed 132 tool type that is open to uniform 72 airflow. A dynamic reducer 68 has means to attach to the tool bracket 140 rim 66 to absorb shock from the tool 50a operation, but the dynamic reducer 68 can be removed for reducing tool 50a weight.

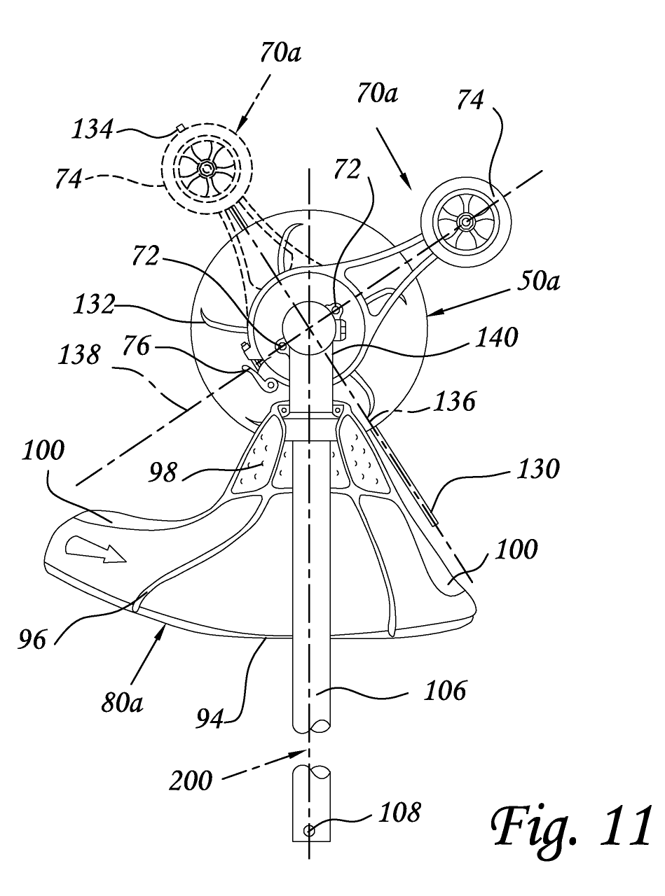

Referring to FIG. 11 and FIG. 1, a string trimmer 200 output arm has the button 108 coupled to the input arm 20a in support of grounds tool 10a operation. The string trimmer 200 grooms lawns between left and right parallel vertical isometry folds. The front suspension 70a and shield 80a further support the grounds tool 10a operation. front suspension 80a helps to maintain the line filament 130 in a straight setting. As the line filament wears, the front suspension 70a can be adjusted to align with the line filament to save time and material costs. If desired, the front suspension 70a can be removed from a cam dial 76 to shed weight along wide open horizontal trimming areas. The front suspension 70a is positioned substantially in front of the operator shield 80a to evenly dampen horizontal trimming response which leads to less debris inside the tool bracket 140 chamber. It is important to note that the featherlike front suspension 70a is implemented on grounds tools 10a to restrict vertical and lateral pivot motion during miles of transport. This type of grounds tool 10a support prevents bending of the boom 102, but the front suspension 70a can be held above resilient grounds cover as well. The front suspension 70a can be vented for aerodynamics and shedding of weight.

Still referring to FIG. 11 and to FIG. 1, the string trimmer 200 operator shield 80a has sidewalls 100 folding up towards distal ends where the operator shield 80a radian arc is at least about twice the tilt of the boom 102 holding angle whereas bladed 132 tool shields provide about ten or more degrees of radian protection. The operator shield 80a mounts to the tool bracket or boom with a nut 62 and bolt 64 type fastener or the like fastener with wings. The operator shield 80a distal ends may include flared wings. The operator shield 80a will be able to withstand hard blows similar to the tool 50a impact response. The operator shield 80a can have an outer semi-circular wind tunnel with semi-circular knives to cut the line filament, but the wind tunnel and knives are not essential. The operator shield 80a has a skid and rest 94. The operator shield 80a can provide substantial protection towards the operator. It is preferred that the operator shield 80a be vented 98 at the proximal end, yet is sometimes avoided in the construction technique. The line filament 130 and bladed 132 tools 50a can be attached and adjusted or removed by hand or with tool from the input arm 20a. The line filament string trimmer 200 attachment may use alternative button or dual button means. The operator shield 80a distal radian wall, which is about twice the boom 102 tilt, is complementary and supplementary to the front suspension 70a with respect to equilibrium tool 50a balance.

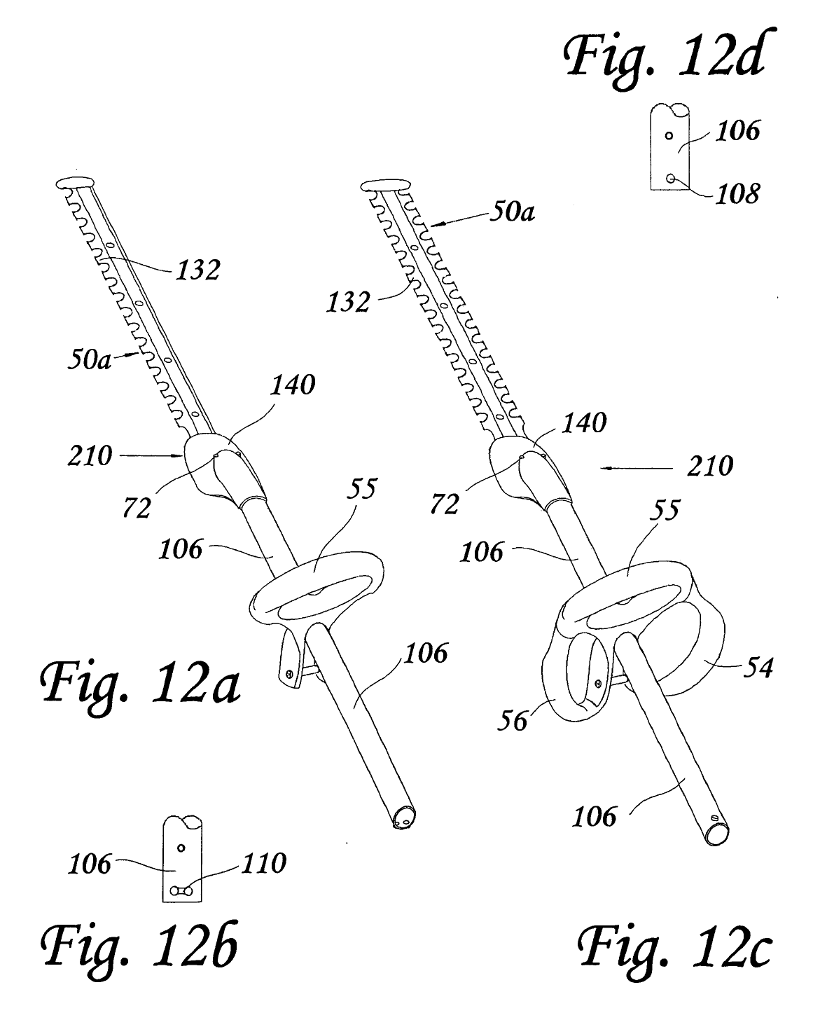

Referring to FIG. 12a-FIG. 12d and to FIG. 1-FIG. 2b, a hedge trimmer 210 embodiment of the invention consists of the button 108 or the dual button 110 output arm 30a arrangement that couples to the input arm 20a for accessible grounds tool 10a operations. The hedge trimmer output arm 210 is attached to the input arm 30a for trimming twig type foliage at about waist level of the operator 144. The hedge trimmer attachment 210 has single or dual reciprocal bladed 132 tool 50a use. boom 102 line of symmetry. The hedge trimmer 210 output arm is on the same line of symmetry as the input arm which permits the tool 50a to make about two-hundred and seventy degree arcs to shape plants into ball shape figures. The technique of shaping plants into balls with wheel type grips prevents operators from letting go of the second control grip 40a to pull on vegetation in the tool 50a danger zone. The third 54 and forth 56 transposable grips are used to prevent fuel spills, the transposable grip folds help keep the operator 144 index finger 142 on the power trigger 30 at all times of operation and twisting of electric power cords is limited when the input arm 20a remains upright with transposable grip folds. It is important that the operator 144 stop the hedge trimming 210 operation by placing their index finger 142 on the first control grip 53 (the index fingers are off of the trigger control) whenever the rotation lock 118 is in an open setting and for every time a transposable grip on the grounds tool 10a is folded into an upright position. The hedge trimmer 210 trigger 30 release technique is critical during grounds transport and other trigger 30 response or idle activities, like how guns are properly held during transport, because hedge trimmer 210 working ends 50a are known to get damaged from poor hand grips. The hedge trimmer 210 must be rested on a safe flat surface before hands are released from the first 53 and second 55 control grips. The operator must never tilt the hedge trimmer 210 more than forty-five degrees The hedge trimmer 210 attachment can be extended from the input arm 20a operation to create grounds tool 10a operations at grounds level or from elevated heights.

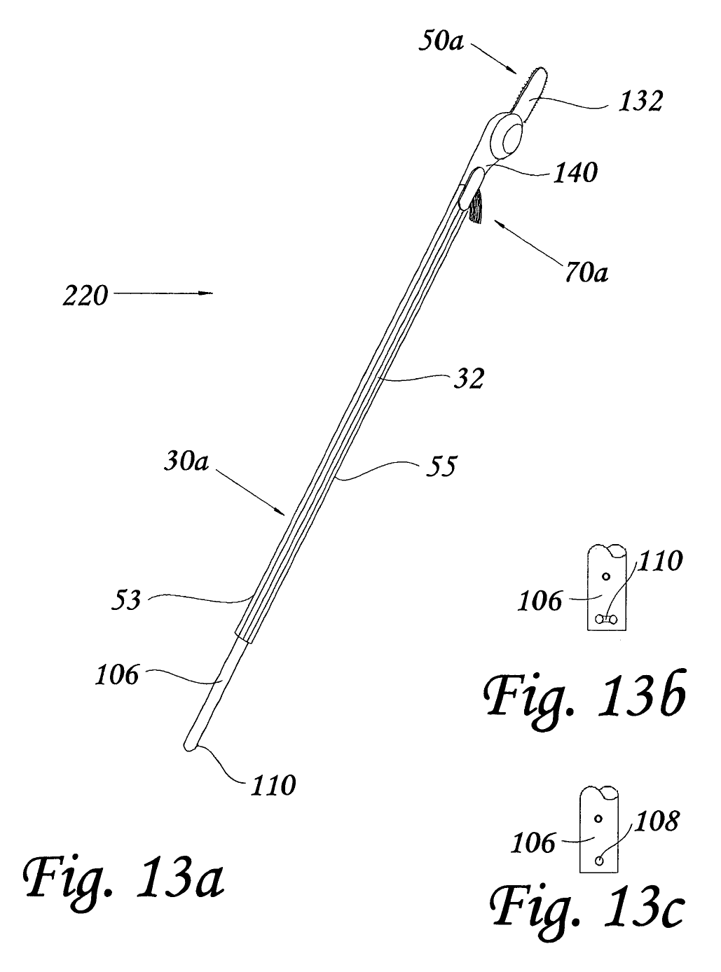

Referring to FIGS. 13a and 13b, a power pruning tool 220 embodiment of the invention is an output arm 30a attachment that couples to the input arm 20a for elevated grounds tool 10a operations about twelve feet or less from ground level. The power pruning tool 220 has a rotary bladed 132 chain type tool 50a and the dual button 110 at the coupler end of the output arm 20a, but the power pruning tool 220 can have a button (not shown) to reposition the input arm 20a into an upright position for less fuel spills, better ergonomics and improved fuel economy. It is preferred, but not essential, to remove the second control grip 55 from the elevated grounds tool 10a so that the boom 102 can be used by the operator 144 in the first control grip 53 overhand position and a balanced underhand position (not shown) for the second control grip 55. It is structurally safer to balance the power pruning tool 220 cantilever attachment in more of a vertical angle far from the dual button 110. A resilient flap 76 or brush type flap may be added to the pole pruning tool 220 bracket 140 or boom 102 to prevent debris from flaking towards the dual button 110.

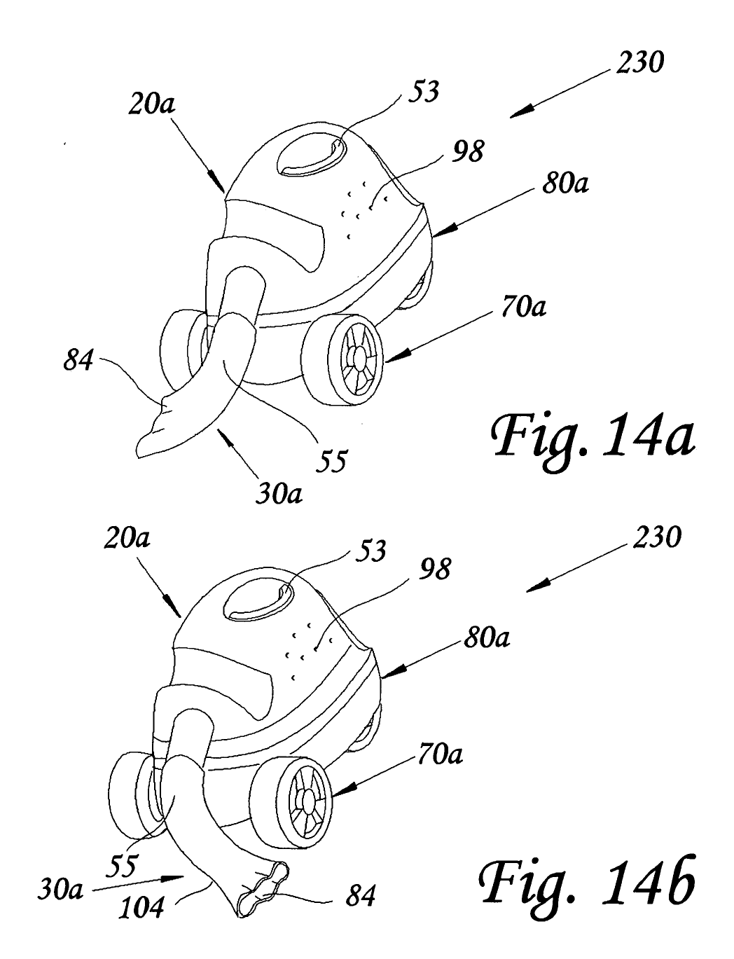

Referring to FIGS. 14a and 14b, a fan bladed blower 230 embodiment of the invention of is an output arm 30a attachment that couples to the input arm 20a for combined grounds level and grounds accessible tool 10a operations. The blower 230 attachment has a motor (not shown) mounted to the input arm 20a with an electric power source being held in an upright position, but the power source 20 can be of the gas or liquid fuel type and the motor can be driven from anywhere on the boom 102 with other power sources. One or more power source back-ups (not shown) are capable of mounting to the input arm 20a that are generally free of spilling liquids along flat grounds surfaces. A fan (not shown) inside the blower 230 is open to uniform air inflow and outflow. The triple wheel front suspension 70a is implemented onto the blower 230 input arm 20a for greater stability and maneuvering of the blower nozzle 84. Accordingly, the blower 230 first 53 and second 55 control grips are capable of folding (not shown) for an operator to push and pull from. The blower 230 has the second 40a control grip located at ground level for the nozzle 84 to fold into the approximate two-hundred and seventy degree mirrored arc, so that the blower 230 can disperse debris from either side of the output arm 20a. The nozzle 84 can be structurally made of different shapes according to sound engineering judgment. Accordingly, the nozzle 84 will produce a narrow vortex (not shown) with an invisible shield that keeps debris dispersion low to ground level or the nozzle will generate wide airflow for more lifting power, as seen in FIG. 14a-14b. A GPS system can be conveniently added to the blower 230 and programmed to follow a vertical lawn trimming path. Other line filament and bladed tools 50a like lawn mowers, string trimmers, tree pruning poles and lawn edging tools can be mounted onto the blower 230. The blower 230 attachment can be converted to an accessible or elevated grounds tool 10a application. It is important to note that all grounds tools are started from the FIGS. 14a and 14b position for safekeeping.

Referring to FIG. 15a-15b, FIG. 7, FIG. 5 and FIG. 1, a brush cutter tool attachment embodiment 240 of the invention is an output arm 30a attachment that strictly connects the dual button coupler to the input arm 20a for grounds level tool 10a operations. The brush cutter 240 has a twenty degree counterclockwise offset bull horn handle made up of the first 30a and second control grip 40a that both branch off from the boom 102 in approximate lateral opposite directions to form the solid barrier bar 52. The first 30a and second 40a control grips maneuver the rotary bladed tool 50a in a set horizontal cutting plane, but the barrier bar 52 illustrated in FIG. 7 also provides acceptable means for lighter horizontal bladed tool 50a work. The brush cutter 240 embodiment comes equipped with an auxiliary span 18 or loop (no shown) harness. The operator shield 80a is at least about forty-five degrees on the second control grip 55 side of the drive shaft 38 housing 106 and at least about thirty-five degrees on the first control grip side of the boom 102. The brush cutter 240 operator shield 80a material will withstand hard blows in proportion to the bladed tool 50a receiving high impact shock. The brush cutter 240 operator shield 80a can be ventilated at a proximal end without directing debris at the lateral bar 52. The power control cable 16 provides a clip 126 that can fasten onto the boom 102 or the input arm 20a (not shown.)

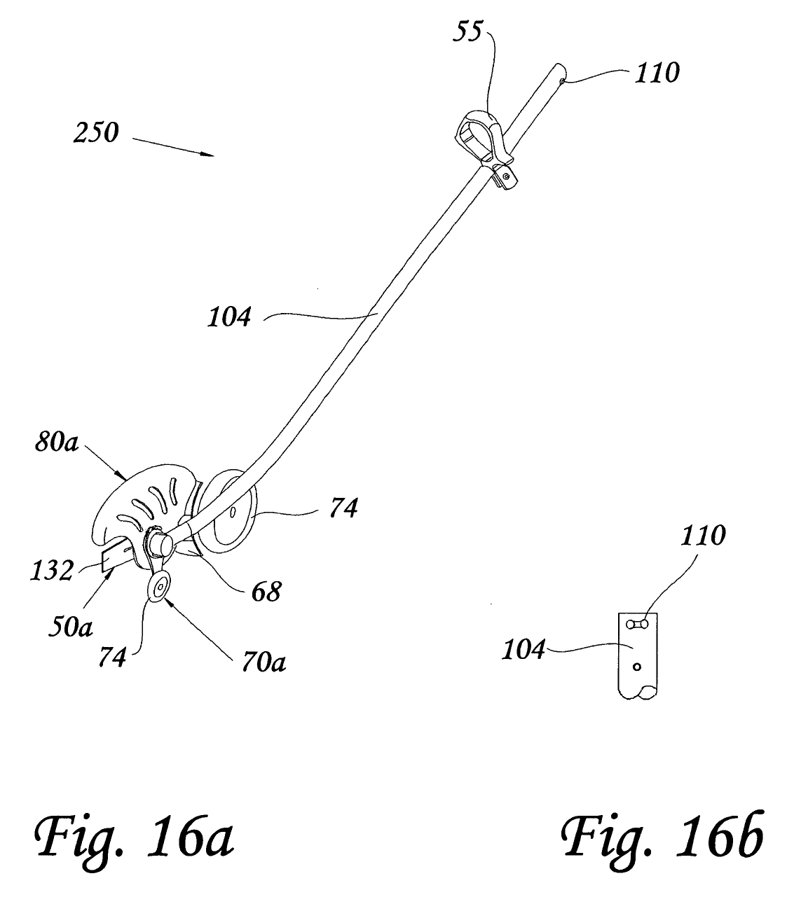

Referring to FIGS. 16a and 16b, a lawn edging tool attachment 250 embodiment of the invention is an output arm 30a attachment that strictly connects the dual button 110 coupler to the input arm 20a for grounds penetrable 10a operations with one or more wheel 74 suspensions 70a attached to the output arm 30a, one or two of which can be easily dialed 86 by hand or by tool when the input arm 20a is decoupled from the output arm 30a to set the offset boom 104 at a good operator 144 index finger 142 control height. The lawn edging tool 250 second control grip 55 is of the single lobe type since grounds operating folds are unnecessary for strict horizontal cutting operations, but the second control grip 40a can be made of a different transverse shape as long as the dual button 110 is anchored into the translation lock 120. The lawn edging tool 250 has the operator shield 80a at least about forty-five degrees on the second control grip side of the boom 102 and at least about thirty-five degrees on the first control grip side of the boom. The lawn edging tool 250 operator shield 80a, like all other bladed tool 50a material, will withstand harsh blows with respect to the bladed tool receiving high impact shock. The lawn edging tool 250 operator shield 80a can be ventilated at a proximal end and curved to disperse more debris from the tool 50a.

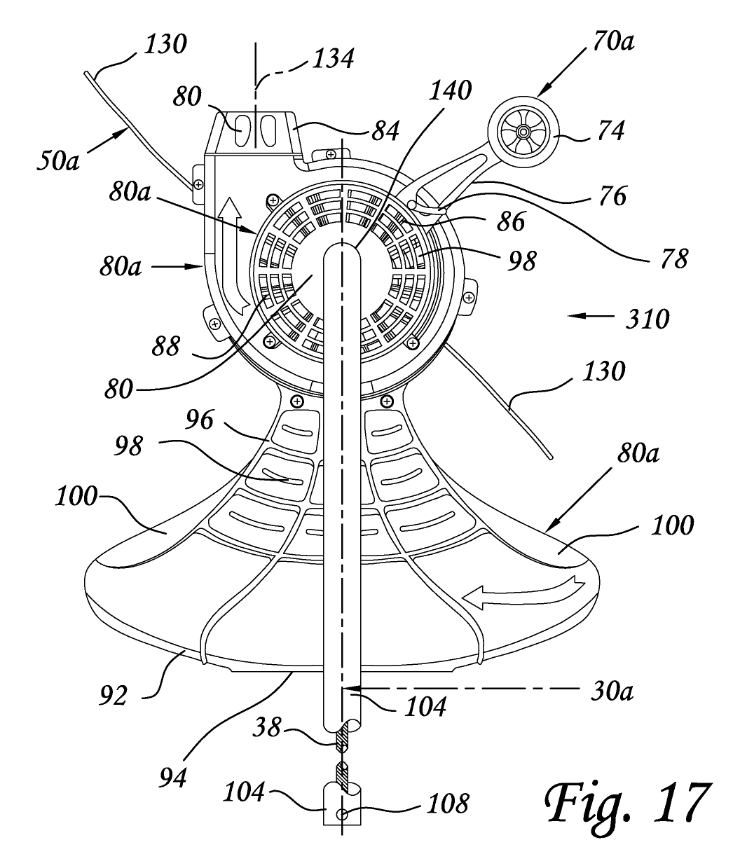

Referring to FIGS. 17a and 17b, a line filament and blower 310 embodiment of the invention has the output arm 20a tool 50a attaching the button 108 to the input arm 20a translation lock for combined grounds tool 10a horizontal and vertical lawn grooming. The trimmer and blower combination 310 provides a plurality of left and right single orthogonal fold combinations, all of which can logically correspond to reduce transport of the grounds tool 10a. It is preferred, but not essential, to use nut 62 and bolt 64 type fasteners for the lawn grooming tool 310 operator shield 70a and tool bracket 140 mounting according to sound engineering judgment. The lawn grooming tool 310 front suspension 70a horizontally rolls the line filament 130 and bladed 132 fan tools 50a around objects free of harm. The lawn grooming tool 310 vertically rolls the line filament 130 and fan 132 approximately adjacent to firm surfaces for minimum tool 50a response caused by grounds resistance. The front suspension 70a has means to fold horizontally for wide fan tool 88 operations or pivot vertically with respect to following the line filament 130 tool 50a return routes. The tool bracket 140 is balanced when the nozzle lines up with the operator shield right side wall while the front suspension 70a lines up with the operator shield left side wall, but the front suspension 70a can be made to dial over to the nozzle 84 position or to the operator shield 80a positions for added second order support of the grounds tool 10a according to sound engineering judgment. The combined blowing and trimming attachment 310 functions in any one of two-hundred and fifty-six combinations (4̂4=256.)

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. A grounds tool with means for transposable grips comprising:
a boom having an input arm and an output arm;
a motor connected to the boom to drive a line filament tool or a bladed tool at the output arm forward working end, the drive system having means to divide into flexible or linear segments on the boom line of symmetry;
the input arm including a first control grip maintaining operative upright relations about earth's origin, the first control grip having an upper track that longitudinally treks from a socket chamber opening to an upper mid-slot, the upper mid-slot further circumferentially linked to two lower mirrored slots, the mirrored slots further linked from a lower double track back to the socket chamber opening;
the output arm comprising a second control grip, the second control grip positioned on the boom line of symmetry, the second grip further positioned between a tool bracket end and a button or a dual-button coupler end of the output arm;
a fulcrum is determined on the boom in the second control grip hand operator holding position whereof the motor is mounted to the output arm, the fulcrum is determined on the boom between the first and second control grips operator holding position whereof the motor is mounted to the input arm and the fulcrum is determined on the boom at the tool end whereof the tool working end is held up by a front suspension and the boom is held up by the operator;
the button coupler having means to pass through the upper track to engage the mid-slot where the engagement forms a translation lock and a transpose lock on the boom from which the first control grip central position is at least ten inches away from the second control grip transposed upright central position;
the dual button having means to pass through the lower track to engage the mirrored slots where the engagement forms a translation lock and a rotation lock on the boom from which the first control grip central position is at least ten inches away from the second control grip upright central position;
the mirrored slots include a recess for an outside device to pry the button or the dual button loose to decouple the input arm from the output arm;
the tool bracket having means for tangential line filament and bladed tools;
the rotation lock compresses forming a rigid boom;
the second control grip having means to transpose a third grip;
the second control grip having means to transpose a forth grip;
the tools left and right isometry folds are congruent with the left and right mirrored slots isometry folds and the control grips transposes;

2. the grounds tool with transposable grips of claim 1, in which: the second control grip having barrier bar means from the left side of the boom facing the tool kickback zone;

3. the grounds tool with transposable grips of claim 1, in which: an operator reverse hand grip transposes the first and second control grips longitudinal isometry folds away from the tool working end congruent isometry folds, an operator overhand grip transposes the first and second control grips lateral isometry folds away from the tool working end congruent isometry folds;

4. the grounds tool with transposable grips of claim 1, in which: the second control grip free to maintain the input arm elements in operative upright positions;

5. the grounds tool with transposable grips of claim 1, in which: the first control grip having means to branch off with respect to the second control grip maintaining the grounds tool equilibrium from an opposite holding position;

6. the grounds tool with transposable grips of claim 1, in which: the first and second control grips free from collapsing towards the tool end;

7. the grounds tool with transposable grips of claim 1, in which: the first and second control grips having means to transpose congruently with the right and left mirrored slots;

8. the grounds tool with transposable grips of claim 1, in which: the tool bracket having tool shield means;

9. the grounds tool with transposable grips of claim 1, in which: the boom and tool bracket having operator shield means, the operator shield having radian walls at least about twice the boom operative tilt;

10. the yard tool with transposable grips of claim 1, in which: the boom and tool bracket having means for a front suspension orientated parallel to the tools tangential planes;

11. the grounds tool with transposable grips of claim 1, in which: the front suspension complimentary and supplementary to the operator shield radian walls, the front suspension having wheel means, the front suspension having dynamic reducing means;

12. the grounds tool with transposable grips of claim 11, in which: the wheel having horizontal means for separating oncoming objects from the line filament and bladed tools, the wheel having vertical means for supporting, rolling and hovering the yard tool over grounds surfaces;

13. the grounds tool with transposable grips of claim 1, in which: the tool bracket having chamber means, the chamber having means to duplicate, reciprocate or reverse the tools tangential motions, the chamber cooled with uniform ambient airflow, the chamber having uniform pressure on lubricants;

14. the grounds tool with transposable grips of claim 13, in which: the chamber having open and uniform fan means;

15. the grounds tool with transposable grips of claim 1, in which: means for a fifth grip positioned on the boom, the fifth grip having means to translate the motor between the tools in the motor and the tool idle speeds, the motor produces less than two-hundred rpm input power variance with respect to the tool output responding to equal or matching grounds resistance;
